(19) United States
(12) Patent Application Publication
(10) Pub. No.: US 2015/0165917 A1
(43) Pub. Date: Jun. 18, 2015

(54) METHOD, SYSTEM AND CHARGER FOR CHARGING A BATTERY OF AN ELECTRIC VEHICLE

(71) Applicant: ABB B.V., Rotterdam (NL)

(72) Inventors: Egbert Wouter Joghum Robers, Delft (NL); Lars Peter Bech, Delft (NL); Crijn Bouman, Den Haag (NL); Ali Ugur, Den Haag (NL); Martijn Halbo Dirkse, Delft (NL); Marcus Van De Veerdonk, Eindhoven (NL)

(73) Assignee: ABB B.V., Rotterdam (NL)

(21) Appl. No.: 14/369,885

(22) PCT Filed: Dec. 18, 2012
(86) PCT No.: PCT/NL2012/050896

§ 371 Date: Jun. 30, 2014

(30) Foreign Application Priority Data
Dec. 29, 2011 (NL) 2008058

(51) Int. Cl. B60L 11/18

(52) U.S. Cl. CPC B60L 11/1809

(57) ABSTRACT

The present invention relates to a method, a charge controller, a charger and charging system for charging a battery of an electric vehicle, which can include a) determining a priority for each port where an electric vehicle is connected, b) assigning a maximum available power budget to a port with first priority, c) performing a charge session at the port with the first priority, d) monitoring actual power delivered to the vehicle from the priority port, e) adjusting the power budget value of the priority port depending on the actual power delivered to the vehicle and f) assigning a remaining portion of the power budget to the port with the second highest priority, g) if the power budget exceeds a predetermined threshold value, starting or restarting a charge session at the port where the remaining portion of the power budget is assigned, and h) repeating steps e-h.

The present invention relates to a method, a charge controller, a charger and charging system for charging a battery of an electric vehicle according to the Chademo protocol. The charging process of an electric vehicle is a time consuming process. For that reason, fast-chargers are made available at various charging points, for instance in urban areas.

WO 2011/134861 discloses a distributed electrical power system comprising a plurality of rechargeable electrical vehicles coupled to a common electrical power grid at remote locations. A dispatch controller is configured to regulate the charging priorities and charging current characteristics of the rechargeable power units. The publication does not relate to the Chademo protocol and moreover, not even to adjusting the assigned power budget value of the priority port depending on the actual power delivered to the vehicle. Instead, it is based on continuous computations of charging times and characteristics to achieve target charge levels. The charging is performed until a target charge level is met, not until a power budget is depleted, based on measurements of the received power.

EP 0 314 155 discloses the charging of batteries in an order determined by a priority parameter. This publication also doesn't relate to the Chademo protocol, nor to adjusting the assigned power budget value of the priority port depending on the actual power delivered to the vehicle, and that the battery is not located in a vehicle.

A difficulty that arises when placing these fast-chargers are the power ratings of the available power connections. This capacity can be limited by various local factors such as the available power cables, fuses, the power rating of a distribution transformer or the number and rating of operational power modules in the fast-charger. The power rating can also be limited dynamically in some cases by a peak-shaving system, a smart-grid system or so-called load management system. Fast-charging requires a higher power, to transfer a certain amount of charge within a reasonable time. When a vehicle is charged at a fast charger, the power retrieved from the power connection may be such that there does not remain enough power to charge a second or more vehicle batteries simultaneously.

However when limited power capacity is available but one does want to start charging a second car, it is possible to start a charge session of a second vehicle at a lower power. The sum of power delivered to the first and second vehicle should be managed such that it does not exceed the available capacity.

In many fast charging systems the way of working consist of two phases: the initialization phase in which the parameters of the charge session are negotiated and the actual charge session. During the charger session the vehicle can act as a master controller: the vehicle transmits a setting value of charging current control to the charger at a constant time interval. The charger outputs a current that corresponds to the setting value. In the event that the setting value from the vehicle changes, the charger varies output current that follows the new value.

The power at which a charge session is performed is determined by communication between the charger and the vehicle, or a battery management system thereof. This communication takes place on specific protocols for chargers and battery management systems, for example the well known Chademo protocol. A property of some of these protocols is that they allow negotiations about charge power for a charge session, but only upfront, that is, before the charging starts. Once a session has started, it continues at the predetermined power rate. For example according to the Chademo protocol the control parameters for charging, such as the setting point of charging current shall be transmitted from the vehicle to the charger only. This has however, the disadvantage that once more power comes available during a charge session which already started (for example when the first vehicle is fully charged and requires no power anymore), the charging of the second vehicle continues at a lower power than the maximum of power available, and as a result: a longer charge time. It is a goal of the present invention to solve this problem.

The invention thereto proposes a method for charging a battery of an electric vehicle, Comprising a) determining a priority for each port where an electric vehicle is connected, b assigning the maximum available power budget to the port with the first priority, c) performing a charge session at the port with the first priority, d) monitoring the actual power delivered to the vehicle from the priority port, e) adjusting the power budget value of the priority port depending on the actual power delivered to the vehicle and f) assigning the remaining power budget to the port with the second highest priority. g) If the power budget exceeds a predetermined threshold value, starting or restarting a charge session at the port where the remaining power budget is assigned and h) repeating the steps of e-h.

The method according to the invention takes away the disadvantage of the state of the art, wherein a charge session is started and continued at a power level that is negotiated according to a communication protocol that does not allow a change of the power level by the charger after the session has started, which results in an unnecessarily long charging time.

Since these protocols do not enable a changing power level during a session, the charger stops an ongoing charge session when it has determined that available power has increased and comes closer to a demanded power by the vehicle. Once the charge session is stopped, the charger allows to start a new session without unlocking the electric vehicle. For the new session, the protocols permit to negotiate a new value, which may then be chosen more suitable.

The demanded power may not be available at the charger for various reasons. The charger may be connected at a power source, such as a grid, which grid or grid connection (or substation) has a maximum power, or the charger may have multiple secondary power exchange ports, to some of which there is already a vehicle coupled for charging its battery. Such vehicle may have a constant power consumption during a certain time, but in particular when a state of charge is nearly reached, the required power may already decrease. From that moment on, the available power for another vehicle increases.

In a preferred embodiment the invention is implemented as following. A vehicle connects to a charging system and a communication has been setup between the vehicle and charger. The charger allocates a power budget which depends on the priority for each port and if there is vehicle connected to a power exchange port.

The power budget is a virtual value which is calculated by software and kept in a software application or stored inside a digital storage medium such as a memory. The maximum deliverable current at a certain charge port is calculated by the charger based on the target voltage and the allocated power budget, the maximum current is then communicated to the vehicle. The vehicle then starts communicating its demanded current, whereupon the charger delivers within a predetermined time and predetermined range the current demanded by the vehicle. The delivered current is continuously monitored by the charger and depending on the actually delivered value the power budget value is increased or decreased. If at the same time a second vehicle is connected to the same charger, the power budget which is available due to the decreasing power demand on the first port is allocated to the second port. Charging at the second port is started with the allocated remaining power budget (or lesser). The power budget which comes free at the first power exchange port is continuously allocated to the second power exchange port. If the allocated power budget at the second port exceeds a certain predetermined level, the charging session at the second exchange port is stopped an re-started with a higher charge power rate to enable faster charging at the second port.

The method according to the invention may therefore further comprise—as long as the demanded power is not available at the charger—repeatedly determining the available power again after a time interval and if more power is available at the charger after the time interval stopping the charge session and starting a new session with more power.

By monitoring the available power this way, the charging time is further decreased, since the difference between the demanded power by the vehicle and the available power is kept low. The interval is to be chosen such that is useful to stop a charge session and to start a new one. Starting a charge session usually takes some time, for instance about half a minute. This time is typically used to perform some safety checks such as isolation monitoring and checking the correct operation of the electrical path in the system. The method may comprise taking a threshold into account, for the difference between the available power and the power level of the actual charge session. When the difference is too small, it makes no sense to stop the session and to start a new one. When the difference is sufficient, the session may be stopped and restarted. Furthermore, a trend in the available power such as increasing power availability may be monitored and it may be decided to anticipate on, or wait for further development.

Determining the power demand by the vehicle may comprise establishing a communication channel between the vehicle and the charger and negotiating a demanded power by communication over the communication channel between the battery management system of the vehicle and communication means of the charger.

Most electric vehicles are equipped with a battery management system that is configured for communication with a charger. A commonly used protocol for this communication is the Chademo protocol. The method according to the invention therefore also relates to determining the power demand and/or performing a charge session comprising charging or communicating according to the Chademo protocol.

The power available at the charger may be determined by a power source or connection, such as a grid connection. A grid connection may be a connection at a local substation, which has a power limit, such as for example 50 kW. Although a power converter of the charger would theoretically be able to charge at a higher rate, the connection to the grid forms the bottleneck. It is also possible that the grid connection can deliver the required power, but the power capacity of the power converter is not sufficient, in that case the power converter forms the bottleneck.

It may also be the case that the demanded power is below the power rating of the power connection, but that the power available at the charger is influenced by another vehicle, coupled to the same charger or a same power source. For instance, when the power rating of the grid connection is 50 kW, and the power converter has multiple secondary power exchange ports, a vehicle coupled to a first power exchange port may demand such amount of power that the remaining power at the charger is below the demand of a second vehicle.

Yet another situation occurs when an owner of multiple chargers have made an agreement of total power consumption with a grid owner. In that case, a power consumption at a first charger may impose limitations to a power available at a second charger. The chargers may thereto comprise communication means for communication with other chargers, directly or for example via a controller which may be formed by a central server.

It may also occur that a single charger or a plurality of chargers is coupled to a smart-grid or load management system which dynamically allocates a power limit over time to the chargers via a communication means or a server network. This may be a dynamic value which is different than the maximum capacity of the local electricity supply connection. The method according to the invention may use this dynamic limit as an input value for determining a power budget.

The invention further relates to a charger for the battery of an electric vehicle, comprising a primary power exchange port for exchanging power with a power source such as a grid, at least one secondary power exchange port for exchanging power with a vehicle, a power converter for converting power between the primary power exchange port and the at least one secondary power exchange port and communication means, for communicating with a battery management system of a vehicle, wherein the charger is configured for determining a power demand of a vehicle to be charged, determining the available power, if the demanded power is available, performing a charge session for delivering the demanded power to the vehicle and if the demanded power is not available, starting a charge session for delivering the available power to the vehicle and determining the available power again after a time interval, and if more power is available after the time interval, stopping the charge session and starting a new session with more power.

In an embodiment a prediction algorithm can be used for changing the allocated power budget over time. For example a profile for a certain vehicle is stored in the central database of the charging based on previous charging sessions. Depending on the charge parameters received during the negotiation a charge profile can be retrieved which then can be used to change the future power budget.

The charger may further be configured for repeatedly determining the available power again after a time interval as long as the demanded power is not available and if more power is available after the time interval, stopping the charge session and starting a new session with more power.

The determination of available power may herein comprise calculating the difference between power available at the primary power exchange port and power exchanged at a second secondary power exchange port at the same or another charger coupled to the same power source. The invention further relates to a system for charging the battery of an electric vehicle, comprising at least one charger as described above.

The charger described in this invention may have some kind of user interface which informs the user on the progress of charging. If this user interface would show every stop and start sequence the user could become confused. Starting and stopping and changing the power levels are technical parameters of the system and should not necessarily explained to the user. The user interface could therefore be configured such that it would represent charging one car as one session regardless of the amount of stop and start events. The user would then not notice the start and stops just be aware of the overall progress of charging his car.

As similar problem could be present when a charger is linked to some kind of payment system. This could for example be a credit card terminal, an online payments system, payments via telephone or text message, or a subscriber management system. In this case it is not desirable that each individual stop-start sequence is seen as a separate session. This could cause the payment system to create many different payments or invoices for one single charge session which would confuse the user and probably also the operator of the charging station, and would most likely lead to higher administrative cost. This problem however could be tackled in a similar matter as with the user interface. The charging system and its software would consider the charge session for one car as one session regardless of the amount of stops and starts during that session. The IT system would represent it as one session and inform the payment method as such.

In an embodiment a charge profile is predicted based on stored measurement data from previous charge sessions. A prediction is done for a certain vehicle type, model or user ID. The charge profile prediction can be used to determine if restarting a charge session will be effective, because in the end the reason for restarting a charge session is to shorten charge time of the electric vehicle.

The invention will now be elucidated into more detail with reference to the following figures, wherein:

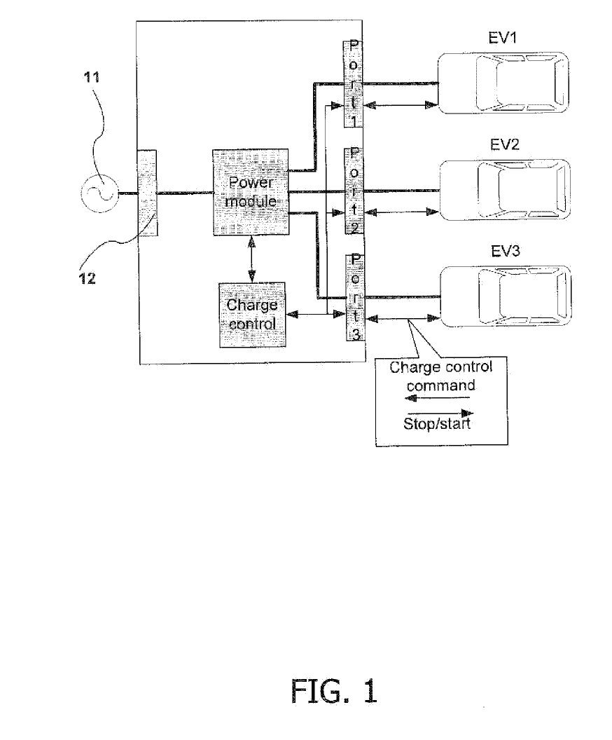

FIG. 1 shows an embodiment of the present invention wherein the charger comprises one module with multiple outputs;

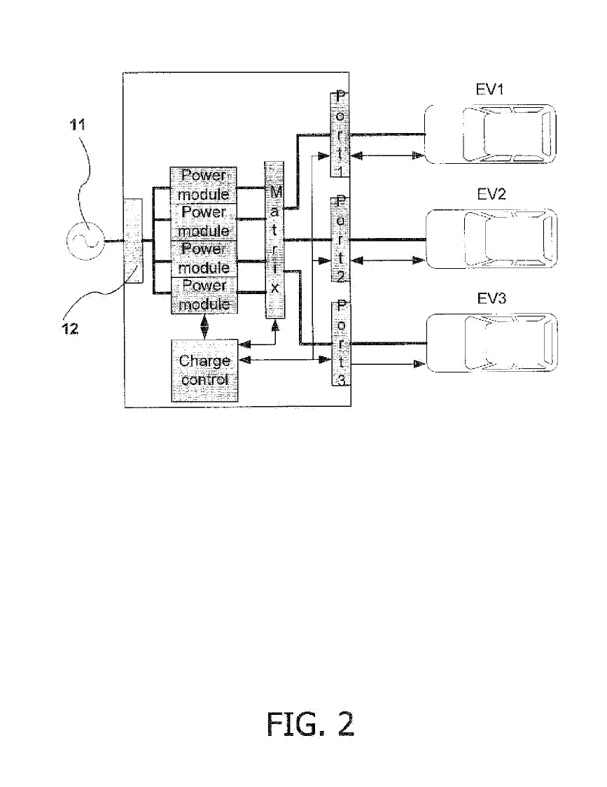

FIG. 2 shows an embodiment of the present invention wherein charger comprises multiple power modules; and

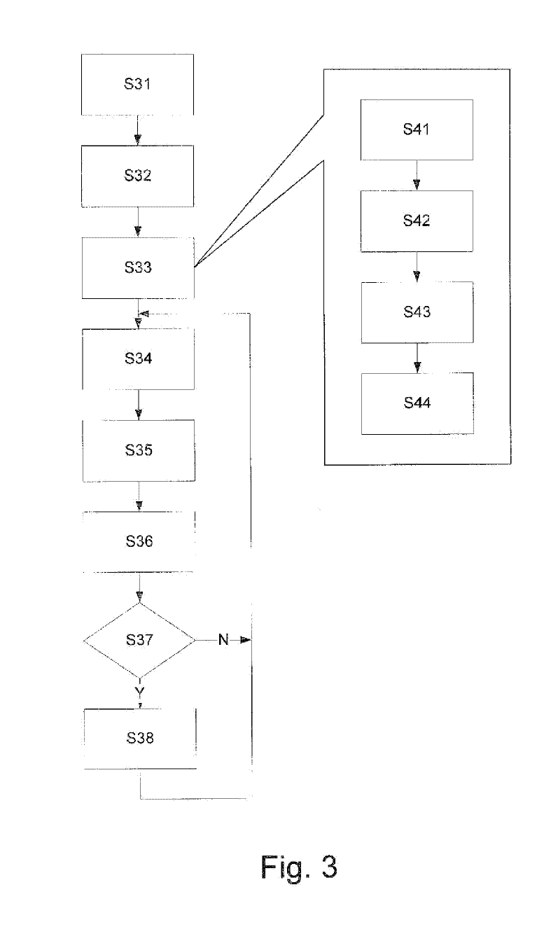

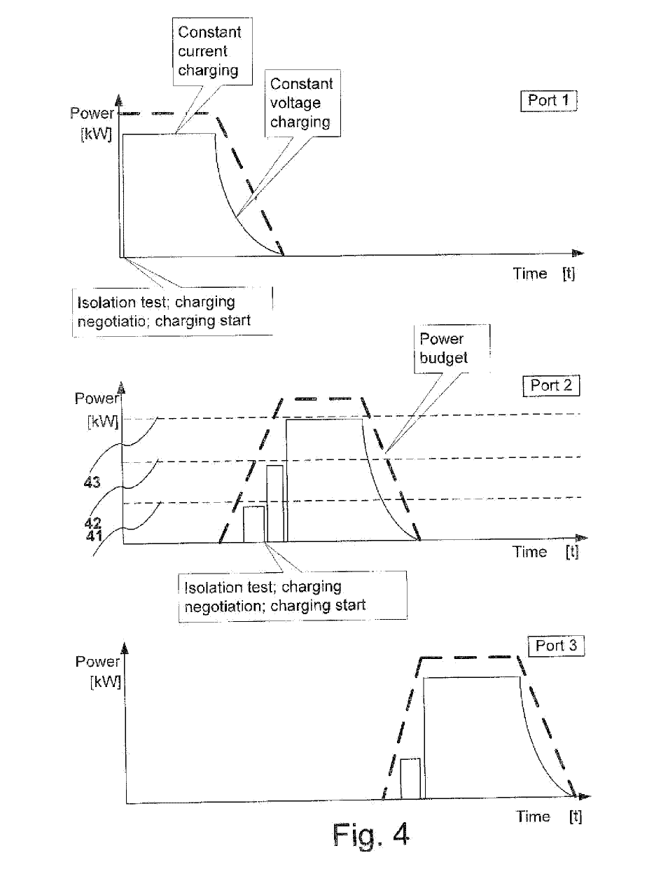

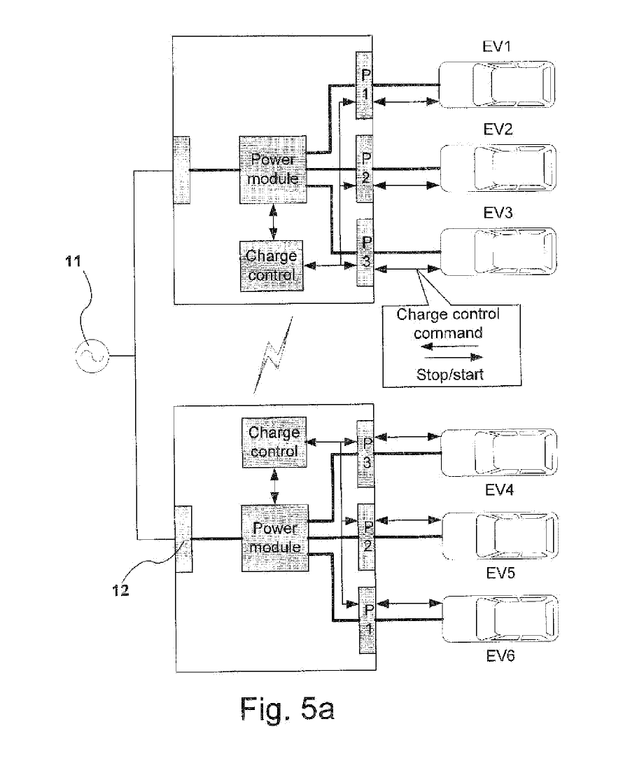

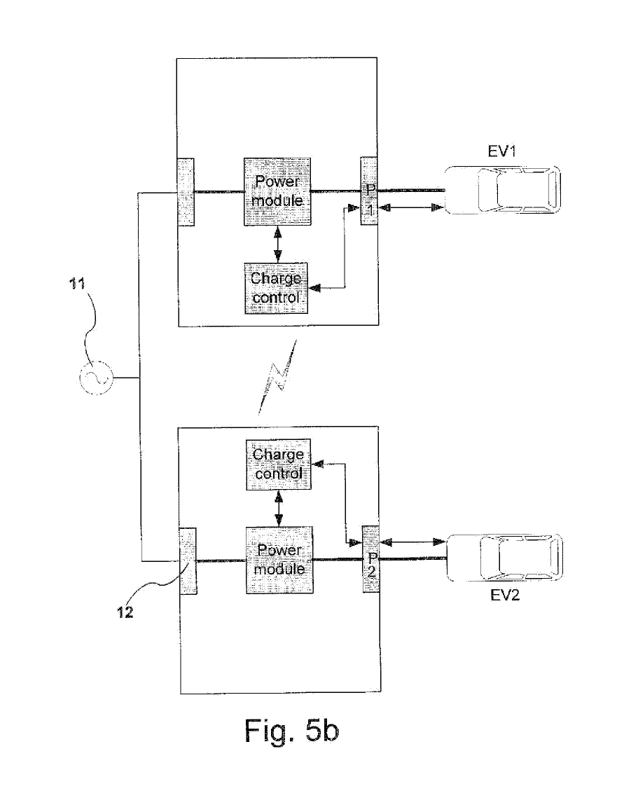

FIG. 3 shows a flow diagram of the method implemented in the charge controller FIG. 4 shows a plot of the charge session on different ports of the charger. FIG. 5a-b FIG. 5a shows a charging system wherein two chargers are connected to the same power source.

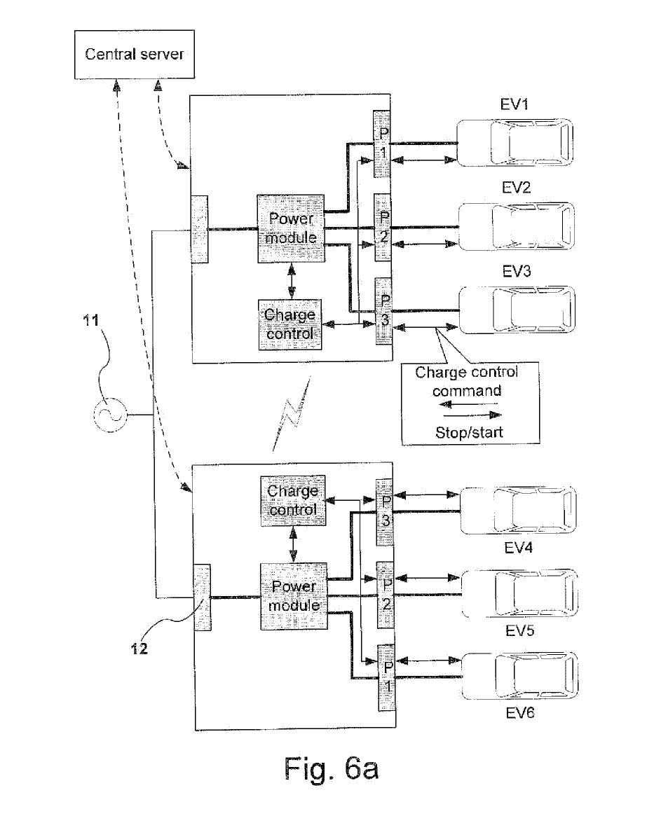

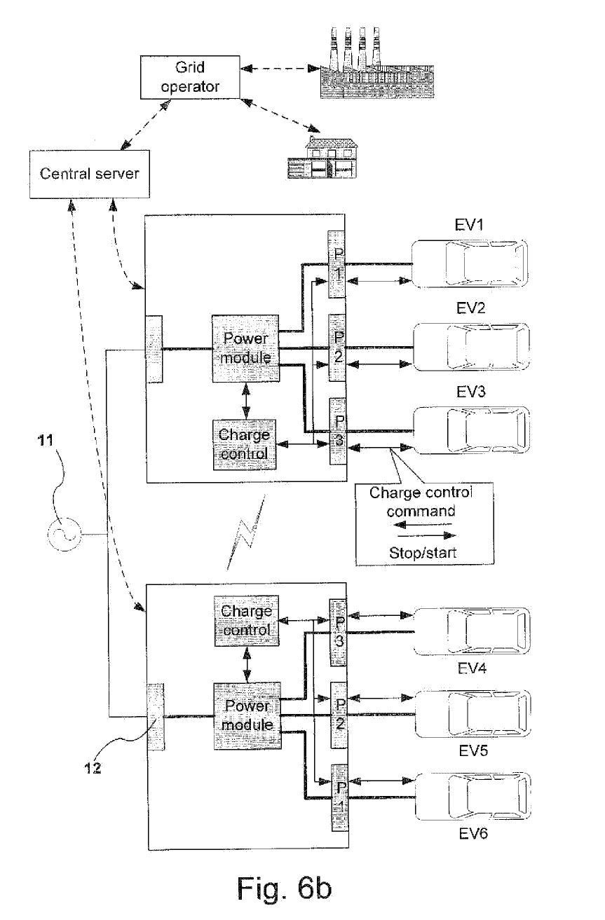

FIG. 6a-b shows the exact situation as in FIG. 5 with the only difference that there is a central server which supervises both chargers and assigns a power budget to both of them.

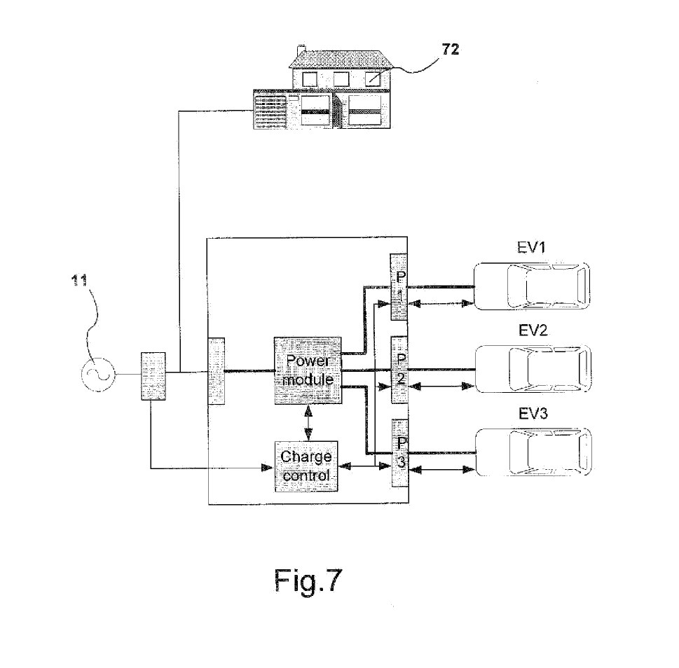

FIG. 7 shows a situation wherein a charger is connected to a power source 11 which also delivers power to housing 72 or any other load with a dynamic power demand.

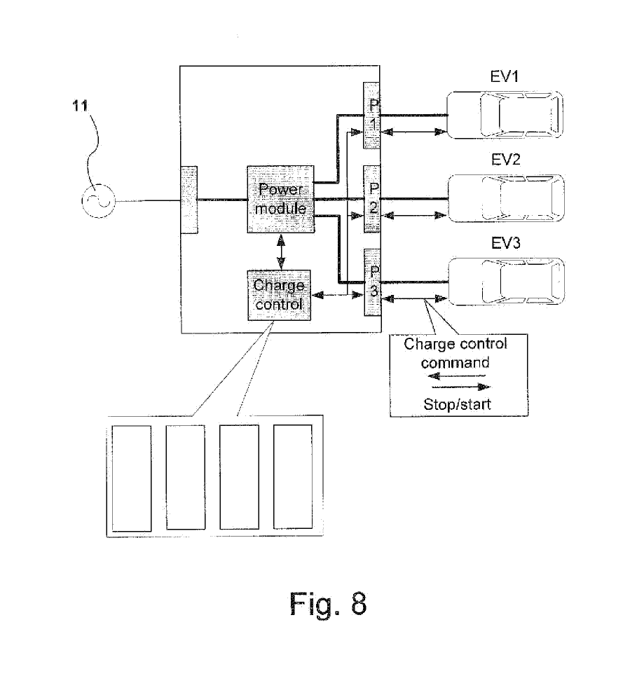

FIG. 8 shows embodiment wherein one of the possible architectures of the power module is given.

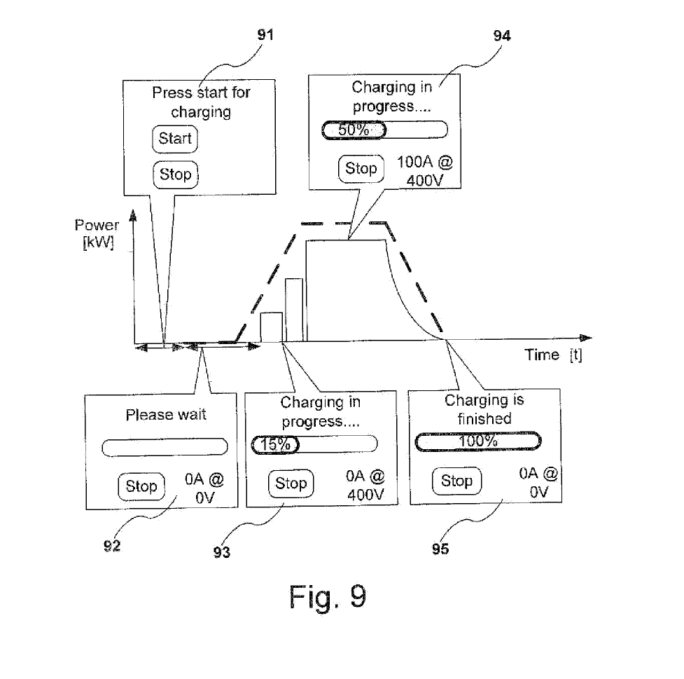

FIG. 9 shows a plot of a charge session, with the corresponding screens on the HMI.

FIG. 1 shows an embodiment of the present invention wherein the charger comprises one module with multiple outputs. The charger comprises multiple power exchange ports for charging a plurality of electric vehicles simultaneously or sequentially. The AC power from the grid is converted by a power module to DC power. The power module has multiple power outputs which can simultaneously service the electric vehicles. Charge control commands like the current setting value are only received from the vehicle during a charge session, the current requested by the vehicle has to be delivered within a predetermined time to the vehicle. In some cases more power is available at the charger. In that case the charger can't take the initiative during a charge session to increase the current level. The charger can only communicate a power level in the initialisation phase, before the charge session. Therefore the charge session on the power exchange port is stopped and restarted by charger to charge the vehicle with an higher current level. The charge controller operates according to claim 1 to increase the current level and charge a plurality of electric vehicles simultaneously.

FIG. 2 shows an embodiment of the present invention wherein charger comprises multiple power modules. To increase the DC power level on the ports the power modules are connected by a switching matrix to a certain power exchange port. The increase of the power level on the power exchange ports can be in discrete steps but also continuously.

FIG. 3 shows a flow diagram of the method implemented in the charge controller.

[S31] Priority is determined for each port where an electric vehicle is connected. The user has to press the start button before a priority is assigned to the port. The vehicle which arrives first is given the highest priority.

[S32] Allocating the maximum available power budget to the vehicle with the first priority.

[S33] A charge session is applied on the port with the first priority. Which comprises the following steps:
[S41] A target voltage is received from the electric vehicle;
[S42] The current budget is determined based on the assigned power budget and the target voltage from the vehicle;
[S43] The current budget is transmitted to the electric vehicle;
[S44] The vehicle starts transmitting current value requests to the charger, wherein the requested current is lower than the power budget.

[S34] The actual power delivered to the electric vehicle is monitored by the charger. If the vehicle requested substantially lower power than the assigned power budget on the port, the power budget is decreased.

[S35] The decreasing the power budget on a certain power exchange port gives us free power budget which is assigned to the port with second highest priority.

[S36] The remaining power budget is assigned to the port with the second highest priority. [S37, S38] If the power budget exceeds a predetermined threshold value, starting or restarting a charge session at the port where the remaining power budget is assigned, else turning to S34. Step S34-to-S37 is repeated until all vehicles are charged. FIG. 4 shows a plot of the charge session on different ports of the charger. On port 1 a vehicle is connected as first one. The maximum power which can be delivered by the port is assigned as power budget to the port. The vehicle starts requesting power which is under the assigned power budget, the power is then delivered by the charger. As seen in the plot, the assigned power budget is given by the dotted line. The solid line gives the actual power delivered to the electric vehicle. The battery of the vehicle is in the first part charged by a constant current, the power delivered to the vehicle is more or less constant. At some point the battery is nearly charged, and the current is topped off. In this past constant voltage charging is applied, the power delivered to the vehicle is decreased. Because the actual power delivered to the vehicle is decreased, the power budget is also decreased and freed power budget is assigned to the next priority port which is port 2. The power budget of the port 2 increases continuously, at some moment a first threshold 41 is exceeded, and a start signal is communicated to the electrical vehicle to begin with a charge session. The vehicle starts charging with a constant power level, at the same time the power budget for port 2 keeps increasing until another threshold level 42 is crossed by the power budget. Because there is an ongoing charge session, a stop command is communicated from the charger to the vehicle to stop the session. The new power budget is communicated to the vehicle, which starts requesting the power level smaller than the power budget, after a time yet another 43 power threshold is exceeded by the port, whereupon a new charge session is restarted with the new power level. The power budget on port 2 does not increase anymore. The charge session on port 2 decreased also its power budget and the remaining power budget is assigned to port 3. The power budget on port 3 is steadily increased and at a certain moment a threshold is exceeded, whereupon the charge session is started with the new power budget.

FIG. 5a shows a charging system wherein two multiport chargers are connected to the same power source. Besides distributing the power budget between a plurality of power exchange ports it also has to be distributed between a plurality of chargers. The chargers operate in the same way as in FIG. 1 or 2 with the difference that the charging ports are not all part of the same charger and the individual chargers also communicate with each other to negotiate power budget. This communication is done by wired or wireless means. The decision for assigning can be done by negotiation between the two chargers, but it also possible that one of the chargers is in master and the other in a slave configuration. It is also possible to connect single-port chargers to the same power source connection, the power is then only distributed between the chargers (FIG. 5b).

FIG. 6a shows the exact situation as in FIG. 5 with the only difference that there is a central server which supervises both chargers and assigns a power budget to both of them. The same configuration is used in cases wherein the chargers are not connected to the power source, but on agreement the chargers cumulatively cannot exceed a power level. Therefore a central server is needed which can communicate with all of them. FIG. 6b shows a setting wherein the central server could receive commands from another system to limit the power of a group of chargers. This limit could be a different value over time. A typical example of this is a demand-response application which is controlled by a utility company, but other possibilities such as any other dynamic power management system or dynamic pricing system exist. The central server receives a maximum value for each moment in time and implements this limit downstream by adjusting the power budgets of the plurality of chargers connected to the system. The chargers in this system can be types equipped with single secondary power exchange ports or multiple secondary power exchange ports, or a combination of the two.

FIG. 7 shows a situation wherein a charger is connected to a power source 11 which also delivers power to housing 72 or any other load with a dynamic power demand. The power demand of the housing is an unknown variable and therefore needs to be measured. The power consumption of the housing is measured by a power measurement device 71 before a total power budget is determined for the whole charger.

FIG. 8 shows embodiment wherein one of the possible architectures of the power module is given. The converter converts the AC voltage of the power source into DC voltage and steps up the converted DC voltage into AC voltage by an inverter. The AC voltage is then applied to the transformer and thereafter to be converted to DC voltage by a rectifier. Other configurations are possible for the power module which will not be treated in this document.

FIG. 9 shows a plot of a charge session, with the corresponding screens on the HMI. An electric vehicle arrives at a charging station where an electric vehicle is already charging on of the charging ports. The newly arrived vehicle is connected to the charger and the start button is pressed on the touch screen display of the charger (91). Because there is no power budget available or the amount of power budget is too low to start a efficient charging session the vehicle has to wait for power budget (92). At a certain moment the allocated power budget for the port exceeds a certain threshold and charging can be started with a power level. The power budget for the port keeps increasing and exceeds a second power budget threshold, the charging is restarted with a higher power level (93). The power budget for the port is still increasing until it reaches the maximum available power budget for the charger, the charging is then restarted with the maximum power level (94). The charging is going on but the actual power demanded by the vehicle goes down, the power budget is adjusted thereon and remaining budget is allocated to another port. The charging finishes when the vehicle is fully charged (95). This example demonstrates how multiple charge session with start and stop sequences can be represented to a user of the system as one single charge session.

1. Method for charging a battery of an electric vehicle according to a protocol which allows advance negotiations about charge power for a charge session, before charging starts, comprising:
a) determining a priority for each port where an electric vehicle is connected;
b) assigning a maximum available power budget to a port with a first priority;
c) performing a charge session at the port with the first priority;
d) monitoring actual power delivered to the vehicle from the first priority port;
e1) adjusting an assigned power budget value of the first priority port depending on the actual power delivered to the vehicle;
f1) assigning a remaining portion of the power budget to a port with a next priority;
g1) if the power budget exceeds a first predetermined threshold value:
starting a charge session at the next port where the remaining portion of the power budget is assigned;
e2) again adjusting the assigned power budget value of the first priority port depending on the actual power delivered to the vehicle;
f2) assigning a remaining portion of the power budget to the port with the next priority;
g2) if the power budget exceeds a second predetermined threshold value:
restarting the charge session at the next port where the remaining portion of the power budget is assigned.

2. Method according to claim 1, wherein a charge session comprises:
receiving a target voltage from the electric vehicle;
calculating a current budget based on at least the assigned power budget and the received target voltage from the vehicle;
transmitting the current budget to the electric vehicle;
delivering the current requested by the electric vehicle until the charging is completed, wherein the requested current is equal or lower than the current budget.

3. Method according to claim 1 wherein the power budget is determined by:
p) number of operational power modules;
q) grid connection fusing;
r) distribution transformer rating;
s) other loads connected to a same connection;
t) local energy storage integrated in the charging system;
u) a demand response system;
v) any other dynamic power management system
w) or any combination of p, q, r, s, t, u, v;

4. A charge controller configured for charging a battery of an electric vehicle according to a protocol which allows advance negotiations about charge power for a charge session, before charging starts, comprising:
a) determining a priority for each port where an electric vehicle is connected;
b) assigning a maximum available power budget to a port with a first priority;
c) applying a charge session at the port with the first priority;
d) monitoring actual power delivered to the vehicle from the first priority port;
e1) adjusting an assigned power budget value of the first priority port depending on actual power delivered to the vehicle;
f1) assigning a remaining portion of the power budget to a port with a next priority;
g1) if the power budget exceeds a first predetermined threshold value:
starting a charge session at the next port where the remaining portion of the power budget is assigned;
e2) again adjusting the assigned power budget value of the first priority port depending on the actual power delivered to the vehicle;
f2) assigning a remaining portion of the power budget to the next port with the next priority;
g2) if the power budget exceeds a second predetermined threshold value:
restarting the charge session at the next port where the remaining portion of the power budget is assigned.

5. A charger for charging a plurality of electric vehicles simultaneously according to a protocol which allows advance negotiations about charge power for a charge session, before charging starts, wherein the charger is in a slave configuration for electric vehicles in a master configuration during the charge session, the charger comprising:
a primary power exchange port for exchanging power with a power source, the power source and/or primary power exchange port being limited by a power rating;
a plurality of secondary power exchange ports for exchanging power with a vehicle, each secondary power exchange port being limited by a power rating;
at least one power converter for converting power between the primary power exchange port and a plurality of secondary power exchange ports, the at least one power converter being limited by a power rating;
wherein a sum of the secondary power exchange port power ratings exceeds the power rating of:
the power source, and/or a limit related to the power source which is implemented in software; and/or
primary power exchange port, and/or at least one power converter;
a charge controller configured for:
a) determining a priority for each port where an electric vehicle is connected;
b) assigning the maximum available power budget to a port with a first priority;
c) applying a charge session at the port with the first priority;
d) monitoring actual power delivered to the vehicle from the first priority port;
e1) adjusting the assigned power budget value of the first priority port depending on actual power delivered to the vehicle;
f1) assigning a remaining portion of the power budget to a port with a next priority;
g1) if the power budget exceeds a first predetermined threshold value:
a. starting a charge session at the next port where the remaining portion of the power budget is assigned;
e2) again adjusting the assigned power budget value of the first priority port depending on the actual power delivered to the vehicle;
f2) assigning the remaining portion of the power budget to the port with the next priority;
g2) if the power budget exceeds a second predetermined threshold value:
b. restarting the charge session at the next port where the remaining portion of the power budget is assigned.

6. A charging system comprising:
at least two chargers for charging a plurality of electric vehicles simultaneously according to a protocol which allows advance negotiations about charge power for a charge session, before charging starts, said chargers being in a slave configuration for electric vehicles in a master configuration during the charge session;
each charger having a primary power exchange port for exchanging power with a power source, the power source and/or primary power exchange port being limited by a power rating;
each charger having a secondary power exchange port for exchanging power with a vehicle, the secondary power exchange port being limited by a power rating;
each charger having at least one power converter for converting power between the primary power exchange port and a plurality of secondary power exchange ports, the at least power converter being limited by a power rating;
wherein the primary power ports of the at least two chargers are connected to a same power source wherein a sum of the secondary power exchange port ratings exceeds the power rating of:
the power source, and/or a limit related to the power source which is implemented in software;
a charge controller configured for:
a) determining a priority for each port where an electric vehicle is connected;
b) assigning a maximum available power budget to a port with a first priority;
c) applying a charge session at the first port with the first priority;
d) monitoring actual power delivered to a vehicle from the first priority port;
e1) adjusting the assigned power budget value of the first priority port depending on actual power delivered to the vehicle;
f1) assigning a remaining portion of the power budget to a port with a next priority;
g1) if the power budget exceeds a first predetermined threshold value:
a. starting a charge session at the port where the remaining portion of the power budget is assigned;
e2) again adjusting the assigned power budget value of the first priority port depending on the actual power delivered to the vehicle;
f2) assigning the remaining portion of the power budget to the port with the next priority;
g2) if the power budget exceeds a second predetermined threshold value:
b. restarting the charge session at the port where the remaining portion of the power budget is assigned.

7. The charger according to claim 1, comprising:
communication means for communication with another charger or a controller.

8. The charger according to claim 1, configured for controlling a power exchange of another charger.

9. The charger according to claim 5, configured for being controlled by a controller or another charger.

10. The charger according to claim 1, configured such that multiple charge sessions performed between a vehicle and the charger are represented as one session to a user of the system.

11. The charger according to claim 1, configured such that multiple charge sessions performed between a vehicle and the charger are represented as one session to a payment application.

12. A charging system for charging a plurality of electric vehicles simultaneously for according to a protocol which allows advance negotiations about charge power for a charge session, before charging starts, comprising:
at least one charger according to claim 5 configured for being controlled by a controller; and
a controller for controlling the at least one charger, configured for receiving a power budget from a grid or utility operator, a demand-response system, smart grid system or a dynamic power management system and controlling the at least one charger according to the received power budget.

13. A method for operating a charger according to claim 1, wherein a decision for starting or, stopping and starting a charge session is based on:
an observed trend in actual power delivered to the vehicles; and/or
a charge profile prediction based on historical data of charge sessions.

14. The charger according to claim 4, comprising:
communication means for communication with another charger or a controller.

15. The charger according to claim 4, configured for controlling a power exchange of another charger.

16. The charger according to claim 4, configured such that multiple charge sessions performed between a vehicle and the charger are represented as one session to a user of the system.

17. The charger according to claim 4, configured such that multiple charge sessions performed between a vehicle and the charger are represented as one session to a payment application.

18. A charging system for charging a plurality of electric vehicles simultaneously for according to a protocol which allows advance negotiations about charge power for a charge session, before the charging starts, comprising:
charging system according to claim 6 configured for being controlled by a controller; and
a controller for controlling the at least one charging system, configured for receiving a power budget from a grid or utility operator, a demand-response system, smart grid system or a dynamic power management system and controlling the at least one charging system according to the received power budget.
